(19) United States
(12) Patent Application Publication
(10) Pub. No.: US 2007/0284359 A1
(43) Pub. Date: Dec. 13, 2007

(54) Scratch resistant slow cooker

(76) Inventor: Mao Yufeng, Suzhou City (CN)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 11/804,272

(22) Filed: May 17, 2007

(30) Foreign Application Priority Data
May 18, 2006 (CN) 200620071617.3

(51) Int. Cl. F27D 11/00

(52) U.S. Cl. 219/433; 219/436

(57) ABSTRACT

A slow cooker is provided, having an outer shell that is formed from an inner layer and an outer layer bonded together by an adhesive, a heating shell fixed within the outer shell, an inner container for holding food positioned within the outer shell, and an electrical heating element in thermal contact with the inner container.

### BACKGROUND OF THE INVENTION

Today, electrical cooking pots, also known as slow cookers, are common household kitchen appliances. Such devices are used for cooking a variety of foods, including rice, vegetables, soups, and stews. For many families, cooking a meal in a slow cooker is attractive because the ingredients may be combined in the morning and left to cook all day, yielding a meal which requires minimal preparation at dinner time. Additionally, slow cookers are particularly appreciated for their capability to prepare lower quality cuts of meat such that they become tender and easy to digest. Slow cooking causes the collagen in the meat to break down into gelatin and the meat fibers to shrink and release the meat juice, making the meat tender.

The general structures of most electrical cooking pots are similar. Referring to FIG. 1, slow cookers typically include a heating shell 5, fixed inside the outer shell 4, an electrical heating band 3 in direct contact with the outside wall of the heating shell 5, and an inner container 6 fixed inside the heating shell 5 to hold food. The heating shell 5 conducts heat from the electrical heating band 3 to the inner container 6. Thus, the inner container 6 is in thermal contact with the electrical heating band 3. The outer shell 4 is usually comprised of metal, typically steel, the outer surface of which is coated with galvanized plating. The galvanized plating provides a physical barrier against corrosion. However, galvanized plating is not an ideal surface for paint because the inert surface does not bond well to the paint. Thus, the painted or printed designs and colors on electrical cooking pots having galvanized plating on the outer shell are extremely susceptible to damage through bumping or scratching. It would thus be desirable to develop an alternative material for the outer shell that is more resistant to damage, yet still prevents corrosion.

### BRIEF SUMMARY OF THE INVENTION

The present invention is directed to a slow cooker having a scratch resistant outer surface. The slow cooker has an outer shell comprising an inner layer and an outer layer, a heating shell fixed within the outer shell, an inner container for holding food positioned within the heating shell, and an electrical heating band in thermal contact with the inner container. The inner layer and outer layer of the outer shell are bonded together by an adhesive. The outer layer may optionally further include a transparent outer coating.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic drawing of a conventional slow cooker (prior art);

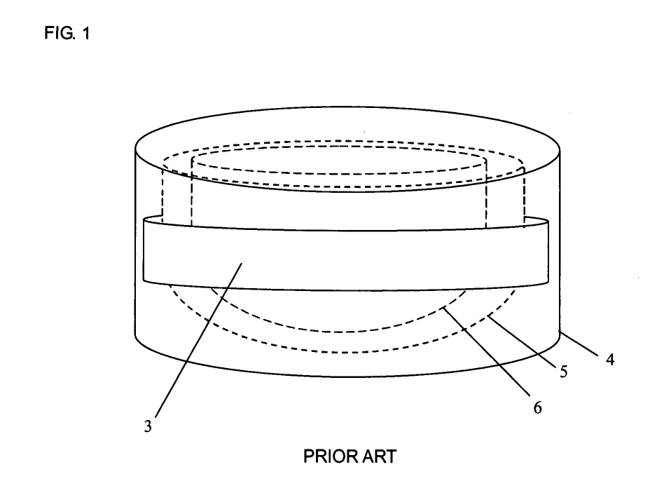

FIG. 2 is a schematic drawing of scratch resistant slow cooker according to an embodiment of the invention; and

FIG. 3 is a cross-sectional profile of the outer shell of a slow cooker according to an embodiment of the invention.

### DETAILED DESCRIPTION OF THE INVENTION

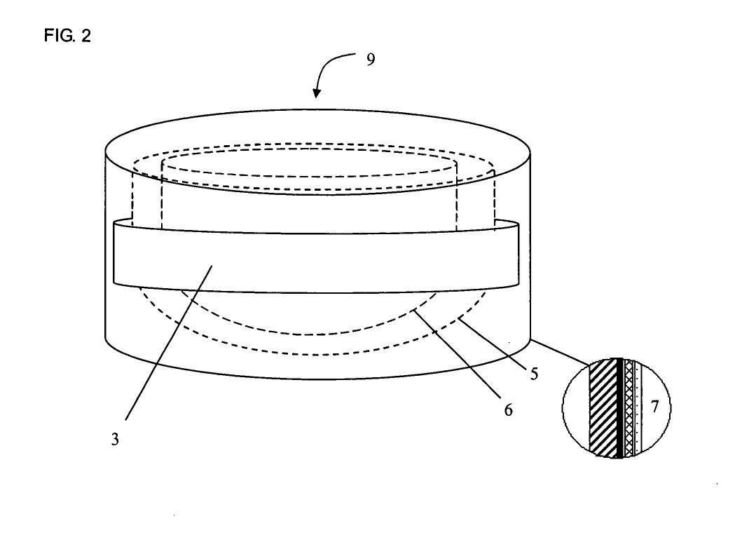

Referring to FIG. 2, the slow cooker 9 according to the invention contains an outer shell 7, a heating shell 5 fixed inside the outer shell 7, an electrical heating band 3 attached to the outside wall of the heating shell 5, and an inner container 6 for holding food, which is positioned within the heating shell 5.

The inner container 6 is preferably comprised of stoneware, typically having a round, oval shaped, or rectangular horizontal cross-section. The inner container 6 is preferably removable from the rest of the slow cooker 9 for ease of cleaning and serving, but may also be fixed within the heating shell 5. The inner container 6 is positioned inside the heating shell 5 during operation.

The heating shell 5 preferably comprises aluminum but it is also within the scope of the invention to utilize alternative materials that provide similar properties. The heating shell 5 is fixed inside the outer shell 7 of the slow cooker 9 and its outer wall is in direct contact with the heating band 3.

The heating band 3 is preferably located around the heating shell 5 and is usually powered by electricity. The heating band 3 should provide sufficient heat to cook food at temperatures of about 175° F. to about 212° F. The heating band may be connected to an electrical cord and powered externally, or may be powered by an internal battery.

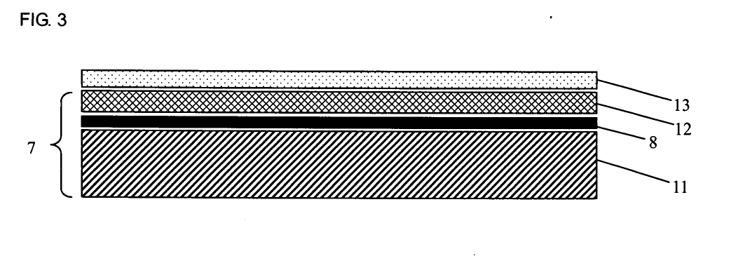

Referring to FIG. 3, the outer shell 7 of the slow cooker 9 comprises at least an inner layer 11 and an outer layer 12. The inner layer 11 may comprise, for example, plated steel, preferably tin-plated steel. However, it is also within the scope of the invention to utilize galvanized (zinc-plated) steel, for example.

Attached to the outer surface of inner layer 11 is an outer layer 12, comprising a film, for example, a polymer film. The outer layer 12 forms the portion of the slow cooker that is visible to the end user, and it is therefore preferable that the outer layer 12 have a physically attractive appearance. An attractive outer layer may be achieved, for example, by using woven fabric, or in the alternative, by using any material that can be extruded or woven into a thin film. A woven PET fabric coating is formed from PET fibers. Outer layer 12 may be colored or patterned for visual interest. For example, the patterns may be preprinted onto the film before or after the film is applied to the outer shell. The fibers may be dyed and woven to produce a colored fabric. Additionally or alternatively, the woven PET fabric may also be decorated by any printing method known in the art.

The outer layer 12 may be applied, for example, by wrapping the outer layer material around the plated steel inner layer 11.

The outer layer 12 and inner layer 11 are bonded together by an adhesive 8 to form the outer shell 7. The adhesive 8 is typically, but not limited to, a polymer bonding agent, such as polyurethane. For example, an outer layer 12 of woven PET coating may be bonded to the inner layer 11 using a polyurethane adhesive, such as type DB83-502A, manufactured by An Gu Chemical. Polyurethane adhesives are particularly preferred because they have excellent flexibility and may be used for adhering materials (e.g., sheet and film) to the contours of an article. Other suitable adhesives include any of those known in the art that are capable of maintaining bond strength while withstanding the cooking temperatures of the slow cooker. The bond strength achieved by the adhesive should preferably be sufficient to ensure that the inner and outer layers of the outer shell do not separate during the life of the appliance.

Referring again to FIG. 3, the outer layer 12 may optionally be coated with a transparent or translucent outer coating 13 in order to further improve the scratch resistance of the surface of the outer shell 7. The outer coating 13 may comprise, for example, a transparent PET film. The outer coating 13 may, for example, be formed by extrusion or may be formed by any other known method of producing a film coating. The outer coating 13 may be applied by any film application method known in the art, for example, by wrapping directly onto the outer shell. When applied to the outer surface of the outer layer 12, this transparent film coating protects the inner and outer layers and the patterns applied to the outer layer.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A slow cooker having a scratch resistant outer surface comprising:
an outer shell comprising an inner layer and an outer layer comprising a woven fabric, wherein the inner layer and the outer layer are bonded together by an adhesive;
an inner container for holding food positioned within the outer shell; and
an electrical heating band in thermal contact with the inner container.

2. The slow cooker of claim 1, wherein the outer shell further comprises a transparent outer coating covering the outer layer.

3. The slow cooker of claim 2, wherein the outer coating covering the outer layer comprises a transparent polyethylene terephthalate film.

4. The slow cooker of claim 1, wherein the inner layer of the outer shell comprises a metal plated with tin.

5. The slow cooker of claim 4, wherein the metal is steel.

6. The slow cooker of claim 1, wherein the outer layer of the outer shell comprises polyethylene terephthalate.

7. The slow cooker of claim 1, wherein the woven fabric of the outer layer comprises polyethylene terephthalate.

8. The slow cooker of claim 1, wherein the adhesive comprises polyurethane.

9. The slow cooker of claim 1, wherein the outer layer of the outer shell is capable of holding a dye or ink so that decorations or colors may be applied.

10. The slow cooker of claim 1, wherein the inner container for holding food is removably positioned within the outer shell.

11. A slow cooker having a scratch resistant outer surface comprising:
an outer shell comprising an inner layer and an outer layer, wherein the inner layer and the outer layer are bonded together by an adhesive;
an inner container for holding food positioned within the outer shell;
an electrical heating band in thermal contact with the inner container; and
a transparent outer coating covering the outer layer.

12. The slow cooker of claim 11, wherein the transparent outer coating covering the outer layer comprises a transparent polyethylene terephthalate film.

13. The slow cooker of claim 11, wherein the inner layer of the outer shell comprises a metal plated with tin.

14. The slow cooker of claim 13, wherein the metal is steel.

15. The slow cooker of claim 11, wherein the outer layer of the outer shell comprises polyethylene terephthalate.

16. The slow cooker of claim 11, wherein the outer layer comprises polyethylene terephthalate.

17. The slow cooker of claim 11, wherein the adhesive comprises polyurethane.

18. The slow cooker of claim 11, wherein the outer layer of the outer shell is capable of holding a dye or ink so that decorations or colors may be applied.

19. The slow cooker of claim 11, wherein the inner container for holding food is removably positioned inside the outer shell.
